(19) United States
(12) Patent Application Publication
(10) Pub. No.: US 2021/0323205 A1
(43) Pub. Date: Oct. 21, 2021

(54) COSMETIC LIP APPLICATOR

(71) Applicant: ELC MANAGEMENT LLC, Melville, NY (US)

(72) Inventor: Sushil Iyer, Astoria, NY (US)

(21) Appl. No.: 16/854,809

(22) Filed: Apr. 21, 2020

(51) Int. Cl. B29C 45/37

(52) U.S. Cl. CPC B29C 45/372; B29L 2031/7184

(57) ABSTRACT

A method of producing a cosmetic applicator via injection molding is described. In the method, a thermoplastic material is introduced into a mold cavity. The mold cavity comprises a surface which engages the thermoplastic material. The surface may provide micro-etched features recessed therein.

### TECHNICAL FIELD

The invention relates to cosmetic applicators; more particularly, the invention relates to an applicator and a method of achieving a flocked-like structure and an applicator texture within an injection mold.

### BACKGROUND OF THE INVENTION

Currently, soft, velvety structures on applicators are achieved via conventional flocking methods, in which fine fibers are sprayed/deposited on a surface or a polymeric base material shaped to the desired applicator design. Strong, compatible adhesives are required for the flocking to successfully adhere to the base material. Additionally. the spraying process of flocking requires the applicator base material polymeric material to have a minimum rigidity for it to be steady or physically stable enough to withstand flocking forces. This usually requires pretreatment of the base material to obtain optimal surface energy to attract the fibers to be flocked. Also, any selective flocking of surfaces requires masking which lowers quality and consistency. Masking is a common process in conventional decoration to cover or mask an area of an article which is not to be flocked or decorated with a barrier. This prevents the flocking or decoration from being deposited on that covered or masked area of the article. The covering of that area is an additional process and material waste.

Flocking of cosmetic applicators is typically achieved during a secondary process. Polymeric parts are formed during thermoplastic processing, such as injection molding, and then subjected to pre-treatment followed by a secondary flocking process which includes application of an application and fiber deposition on the surface of the polymeric part. The part being flocked requires a rigidity of at least 60 Shore A hardness for the part to be stable during the flocking process.

The present invention is provided to solve the problems discussed above and other problems, and to provide advantages and aspects not provided by prior applicators of this type. A full discussion of the features and advantages of the present invention is deferred to the following detailed description, which proceeds with reference to the accompanying drawings.

### SUMMARY OF THE INVENTION

A first aspect of the present invention is directed to a method of producing a cosmetic applicator, according to an embodiment of the present disclosure. The method comprises the step of introducing a thermoplastic material into a mold cavity, and the mold cavity may provide a surface which engages the thermoplastic material. The surface may provide a plurality of micro-etched features recessed therein.

The present invention may include one or more of the following features, alone or in any reasonable combination. Each micro-etched feature may have a depth between 0.08 millimeters (mm) and 0.35 mm. The surface of the mold cavity may comprise one or more smooth areas, the one or more smooth areas comprising at least one of a non-micro etched surface or a micro-etched surface having a depth less than 0.08 mm. Each of the plurality of micro-etched features may be separated by a first smooth area of the one or more smooth areas. The depth of a first micro-etched feature may not be equal to the depth of a second micro-etched feature. A pattern of the plurality of micro-etched features may define a flocking geometry. The mold cavity surface may have a distal end separated from a proximal end by an intermediate portion, wherein the flocking geometry may be at least partially defined by a first set of micro-etched features in the intermediate portion having a deeper depth than the respective depths of a second set of micro-etched features in the plurality of micro-etched features and a third set of micro-etched features in the plurality of micro-etched features. The distal end of the mold cavity may be configured to produce a free end of the applicator, and the proximal end of the mold cavity may be configured to produce at least a portion of a handle of the applicator. The mold cavity may taper from the intermediate portion to the distal end such that a cross-sectional area of the mold cavity taken transverse to a length of the mold cavity at the distal end is less than a cross-sectional area taken transverse to the length of the mold cavity in the intermediate portion. The mold cavity is formed within a mold body, the mold body comprising a first mold body portion in face-to-face relationship with a second mold body portion wherein a first portion of the mold cavity is recessed within the first mold body portion and a second portion of the mold cavity is recessed within the second mold body portion. The plurality of micro-etched features may be located within one of the first portion of the mold cavity or the second portion of the mold cavity. The thermoplastic material may have a hardness less than or equal to 60 Shore A. The thermoplastic material may be an elastomer. The method may further comprise the steps of:
i. introducing the thermoplastic material into the mold cavity at a temperature greater than a temperature at which the thermoplastic material melts, such that the thermoplastic material is in a completely molten state; and
ii. solidifying the thermoplastic material within the mold cavity such that the mold cavity surface finish is transferred to the applicator as the thermoplastic material solidifies.

A second aspect of the present invention is directed to an applicator produced according one of the methods defined as above. The applicator comprises a head of a thermoplastic material positioned about a longitudinal axis. The head has a distal end forming a free end of the applicator and a proximal end terminating in a handle. The head further comprises an exposed outer surface. A plurality of flock-like extensions extending radially outwardly from the exposed outer surface in relation to the longitudinal axis and integrally formed with the head.

A third aspect of the present invention is directed to a cosmetic applicator, according to an embodiment of the present disclosure. The cosmetic applicator comprises a head of a thermoplastic material positioned about a longitudinal axis. The head has a distal end forming a free end of the cosmetic applicator and a proximal end terminating in a handle. The head further comprises an exposed outer surface. A plurality of flock-like extensions extending radially outwardly from the exposed outer surface in relation to the longitudinal axis. Each flock-like extension in the plurality of flock-like extensions is from the thermoplastic material and is integrally formed with the head.

The fourth aspect of the present invention may include one or more of the following features, alone or in any reasonable combination. Each flock-like extension in the plurality of flock-like extensions may have a length extending at least 0.08 mm from the exposed outer surface of the applicator. The length of each flock-like extension in the plurality of flock-like may extend no more than 0.35 mm from the exposed outer surface of the applicator. The plurality of flock-like extensions may be arranged in a flocking geometry, and the distal end of the applicator is separated from the proximal end of the applicator by an intermediate portion, and wherein the flocking geometry is at least partially defined by the length of a first set of the plurality of flock-like extensions extending radially outwardly relative to the longitudinal axis in the intermediate portion being greater than respective lengths of a second set of the plurality of flock-like extensions at the distal end of the applicator and a third set of the plurality of flock-like extensions at the proximal end of the applicator. The exposed outer surface of the cosmetic applicator may comprise one or more smooth areas, the one or more smooth areas comprising at least one of a non-flocked region defined by an absence of flock-like extensions or a set of flock-like extensions in the plurality flock-like extensions extending radially outwardly relative to the longitudinal axis having lengths less than 0.08 mm.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIGS. 1A to 1E are side views of cosmetic applicators of the present invention, according to an embodiment of the present disclosure;

FIG. 2 is partial cross-section of a cosmetic applicator of the present invention, according to an embodiment of the present disclosure;

FIG. 3 is an elevational view of a mold for producing cosmetic applicators of the present invention, according to an embodiment of the present disclosure;

FIGS. 4A and 4B are complimentary molds used in an injection molding method of the present invention, according to an embodiment of the present disclosure;

FIG. 5 is a partial cross-section of complimentary molds used in an injection molding method of the present invention to produce, for example, a cosmetic applicator according to FIG. 2, according to an embodiment of the present disclosure;

FIG. 6 is a magnified view at 90× of a mold used in an injection molding method of the present invention showing micro-etched features at a depth of about 0.08 mm, according to an embodiment of the present disclosure;

FIG. 7 is a magnified view at 90× of a mold used in an injection molding method of the present invention showing micro-etched features at a depth of about 0.2 mm, according to an embodiment of the present disclosure;

FIG. 8 is a magnified view at 90× of a mold used in an injection molding method of the present invention showing micro-etched features at a depth of about 0.35 mm, according to an embodiment of the present disclosure;

FIG. 9 is a schematic drawing of a portion of a mold body showing a micro-etched area and a smooth area of a mold cavity surface, according to an embodiment of the present disclosure;

FIG. 10 is a schematic drawing of a portion of a mold body showing a micro-etched area and a smooth area of a mold cavity surface, according to an embodiment of the present disclosure; and

FIGS. 11A and 11B are magnified views, by 20× (11A) and 100× (11B), of cosmetic applicators, according to an embodiment of the present disclosure.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a novel method of producing a flocked effect in applicators, according to an embodiment of the present disclosure. The method achieves the flocked effect in a single injection molding process with the addition of a secondary process to apply fibers to the applicator. Accordingly, it follows that an applicator will be produced directly from an injection molding mold with a flock effect on a desired area or portion of the applicator. Therefore, this method does not require the secondary process of flocking a surface of the applicator post-molding.

Because there is no secondary flocking process, there is no requirement to meet minimum rigidity or hardness to achieve a stable flocking process since the flocking effect. Again, the flocking effect is achieved within the tool by a process of the polymeric material flowing into fine flock-like geometrical features etched within a wall or surface of the mold. Therefore, a process of the present invention creates an opportunity to employ materials having a hardness less than 60 Shore A to achieve a molded flocked effect.

The flocked effect is achieved by fine micro and nano scale wells etched by laser into a mold cavity which forms the applicator shaped surface. A thermoplastic plastic material, such as a thermoplastic elastomer (TPE), flows into the wells forming fiber structures and producing a carpet-like surface.

A preferred method to ensure material flow into the wells comprises application of induction rapid heating into the cavities. Distances between the wells, depths of the wells, and geometries of the well cross-sections can be varied along the a single surface of the applicator and tailored to provide different and customized applicator feel, cosmetic product pick-up (take-up of the product onto the flocked effect applicator), and cosmetic product pay-off (transfer of the cosmetic product from the flocked effect applicator to the users) as experienced by a user.

Additionally, these mold cavities and resulting flocked effect can be applied to select partial surfaces of the applicator to design partially flocked effect surfaces within the injection mold cavity to tailor targeted application. It should be appreciated that a desired range of material melt flow index is between 5 to 400.

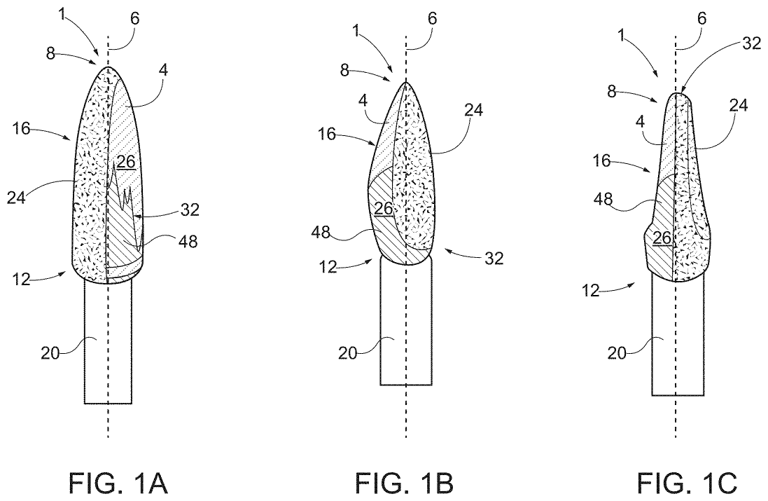

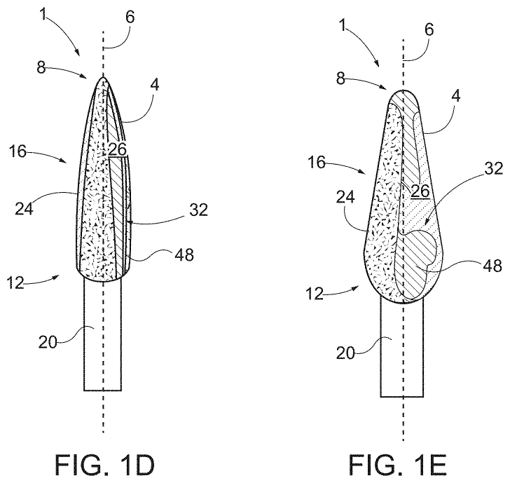

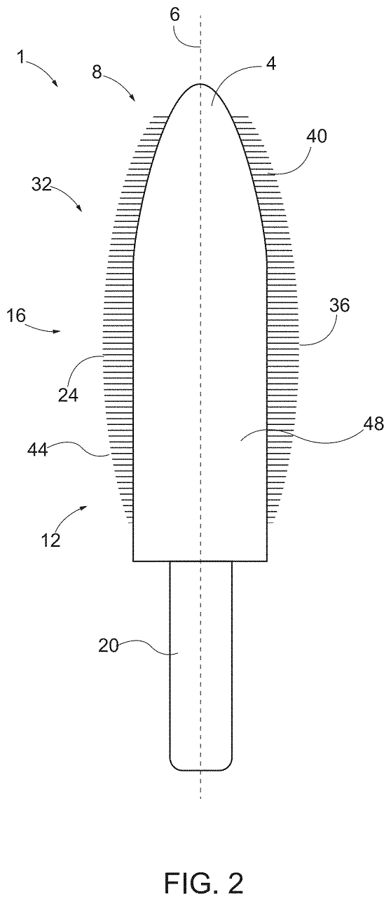

Referring to FIGS. 1 and 2, applicators 1 of the present invention are illustrated. These applicators are generally used to transfer cosmetics, for example lip cosmetics, from a container to a portion of the user, for example the user's lips. It should be noted that the principles of the invention can be employed to produce suitable applicators used to deliver or transfer any suitable cosmetic. It should be appreciated that applicators include, but are not limited to, lip, brow, cheek, and other types of applicators.

Each applicator 1 generally includes an applicator head 4 positioned about a longitudinal axis 6. The applicator head 4 can be any suitable shape. Some popular designs include substantially spade-shaped, bullet-shaped, teardrop-shaped etc. Each applicator 1 has a distal end 8 separated from a proximal end 12 by an intermediate portion 16. The distal end 8 is generally a free end, and the proximal end 12 generally including a handle 20 and terminating therewith. The handle 20 may be a separate structure attached to the applicator head 4 or integral with the applicator head 4 and extending outwardly therefrom.

The applicator head 4 is produced from an injection moldable material, such as a thermoplastic material. The thermoplastic material may be a thermoplastic elastomer, liquid silicone rubber (LSR) and the like. The injection moldable material has a hardness less than or equal to 60 Shore A.

A plurality of flock-like extensions 24 extends radially outwardly relative to the longitudinal axis 6 from an exposed outer surface 26 of the applicator head 4. Flocking is generally a process of depositing many small fiber particles onto a surface. It is defined as the application of fine particles to adhesive coated surfaces, usually by the application of a high-voltage electric field. It can also refer to a texture produced by the process, or to any material used primarily for its flocked surface. The term “flock-like” as used herein is used to define a condition that mimics the definition of flocking without falling under the scope of the definition of flocking and/or the flocking process as will be described in more detail hereinafter.

Each flock-like extension 24 is formed from the injection moldable material of the applicator head 4. These flock-like extensions 24 are integrally formed with the applicator head 4. In other words, applicator head 4 and the flock-like extensions 24 for a unibody construction without adhesives or other bonding techniques necessary to attach the flock-like extensions 24 to the applicator head 4. This structure is developed in a method of the invention which will be explained in more detail below.

The flock-like extensions 24 are configured to capture a cosmetic upon frictional engagement therewith and deposit the cosmetic onto a user's body part upon a further engagement with the body part, typically using a brushing motion. Accordingly, the flock-like extensions 24 are typically quite small, usually having lengths measured from exposed outer surface 26 of the applicator head 4 to a terminal end 28 of the flock-like extension 24 greater than or equal to 0.08 mm and preferably less than 0.50 mm, more preferably less than 0.35 mm, and most preferably between 0.08 mm and 0.35 mm.

The flock-like extensions 24 are distributed on the exposed outer surface 26 of the applicator head 4 in a flocking geometry 32. The flocking geometry 32 is at least partially defined by a length of a first set 36 of flock-like extensions 24 in the intermediate portion 16 being greater than respective lengths of a second set 40 of the flock-like extensions 24 at the distal end 8 of the applicator 1 and a third set 44 of the flock-like extensions 24 at the proximal end 12 of the applicator 1. Additionally, the flocking geometry 32 is further defined by one or more smooth areas 48 on the exposed outer surface 26. These smooth areas 48 generally include at least one of a non-flocked region 52 defined by an absence of flock-like extensions or a set of flock-like extensions in which the flock-like extensions extending radially outwardly from the exposed outer surface 26 relative to the longitudinal axis 6 have lengths less than 0.08 mm. The smooth areas 48 can form boundaries about a set of flock-like extensions 24 having lengths greater than those on the smooth areas 48, to the extent the smooth areas 48 have flock-like extensions 24 at all.

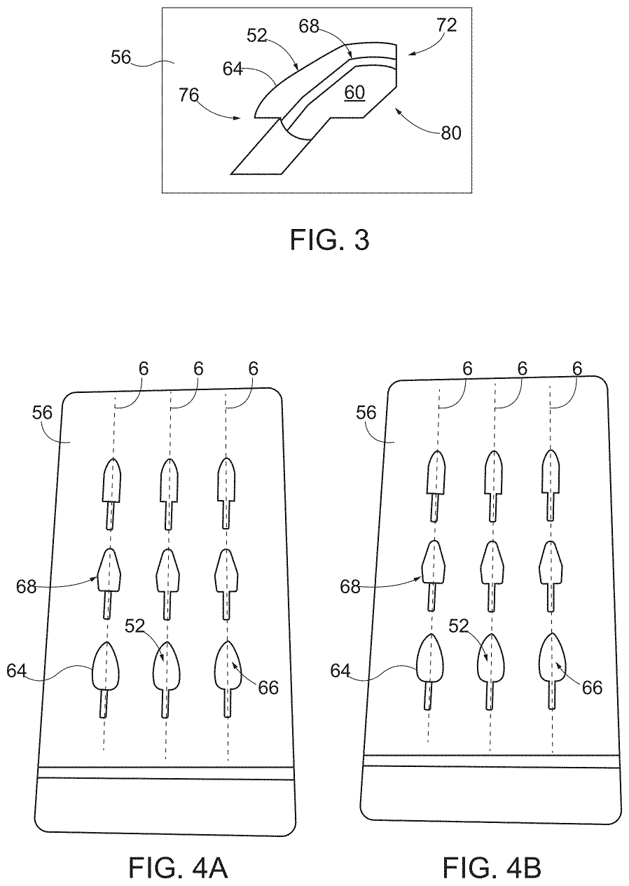

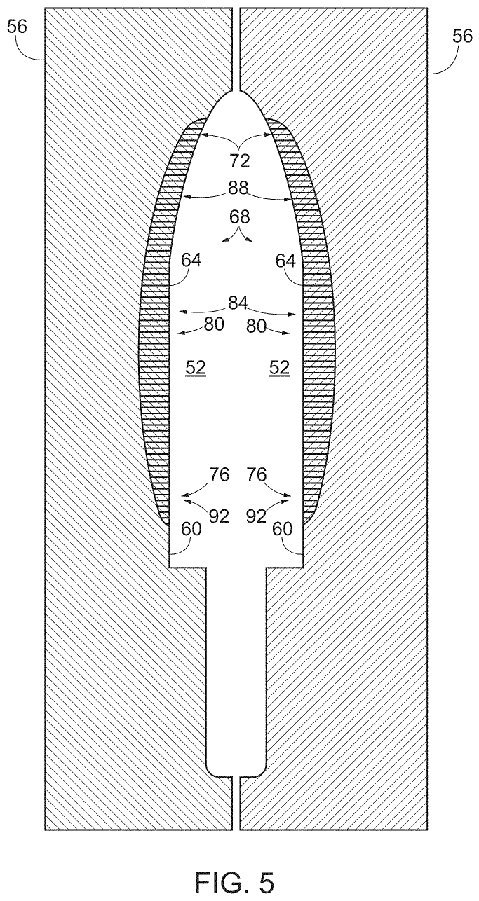

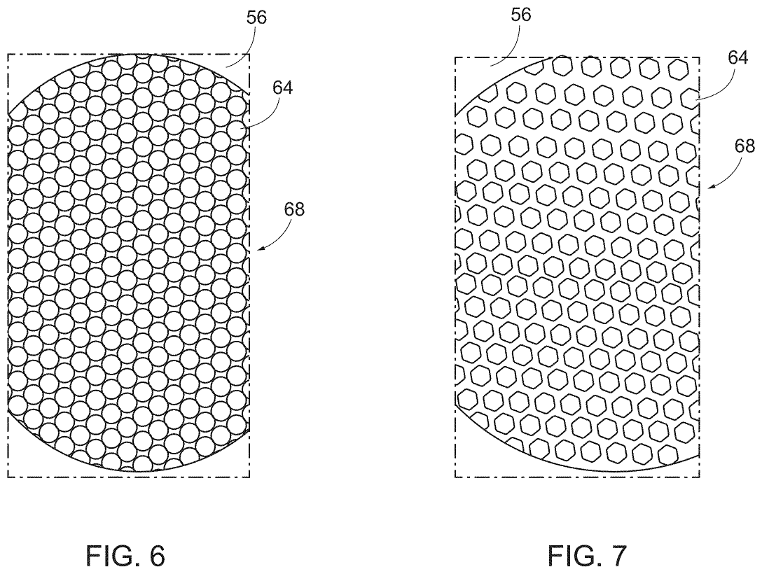

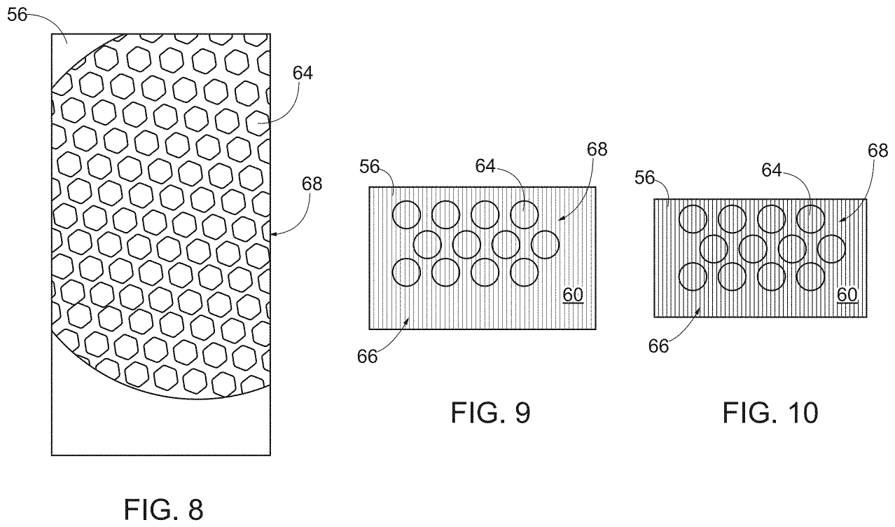

A method of the present invention involves injection molding a cosmetic applicator. The method includes the step introducing an injection moldable material, typically a thermoplastic material, into a mold cavity 52 of a mold body 56. The mold cavity 52 comprises a surface 60 which engages the thermoplastic material. The surface 60 comprises a plurality of micro-etched features 64 recessed therein. Mold bodies are illustrated in FIGS. 3-10. The mold body 56 may generally formed in two pieces, both having a portion of the mold cavity 52 recessed therein. 10. (See FIGS. 4A, 4B and 5). These portions are brought into face-to-face relationship during the injection molding process.

The micro-etched features 64 are provided to form the flock-like extensions 24 during an injection molding process as the injection molding material solidifies. It follows that dimensions of micro-etched features are similar to dimensions of the flock-like extensions 24 on the finished applicator 1. Each micro-etched feature has a depth between 0.08 mm and 0.35 mm. Each of the plurality of micro-etched features 64 may be separated by a smooth area 66 of the surface 60. The micro-etched features 64 are located within one or both of the first portion of the mold cavity 52 or the second portion of the mold cavity 52.

The mold cavity 52 also controls the flocking geometry 32. A pattern of the plurality of micro-etched features defines the resultant flocking geometry 32. Accordingly, the surface 60 of the mold cavity 52 comprises micro-etched areas 68 and one or more smooth areas 66. The one or more smooth areas 66 comprise at least one of a non-micro etched surface or a micro-etched surface having a depth less than 0.08 mm.

Additionally, according to the flocking geometry 32, respective depths of micro-etched features 64 may not be equal. For example, the mold cavity surface 60 has a distal end 72 separated from a proximal end 76 by an intermediate portion 80. The flocking geometry 32 is at least partially defined by a first set of micro-etched features 84 in the intermediate portion 80 having a deeper depth than the respective depths of a second set of micro-etched features 88 and a third set of micro-etched features 92. This is best illustrated in FIG. 5.

Of course, the geometry and dimensions of the mold cavity 52 control or determine the geometry and dimensions of the applicator 1. It follows that the distal end 72 of the mold cavity 52 is configured to produce the free end of the applicator 1, and the proximal end 76 of the mold cavity 52 is configured to produce at least a portion of the handle 20 of the applicator 1.

Further, the mold cavity 52 tapers from the intermediate portion 80 to the distal end 72 such that a cross-sectional area of the mold cavity 52 taken transverse to a length of the mold cavity 52 at the distal end 72 is less than a cross-sectional area taken transverse to the length of the mold cavity 52 in the intermediate portion 80.

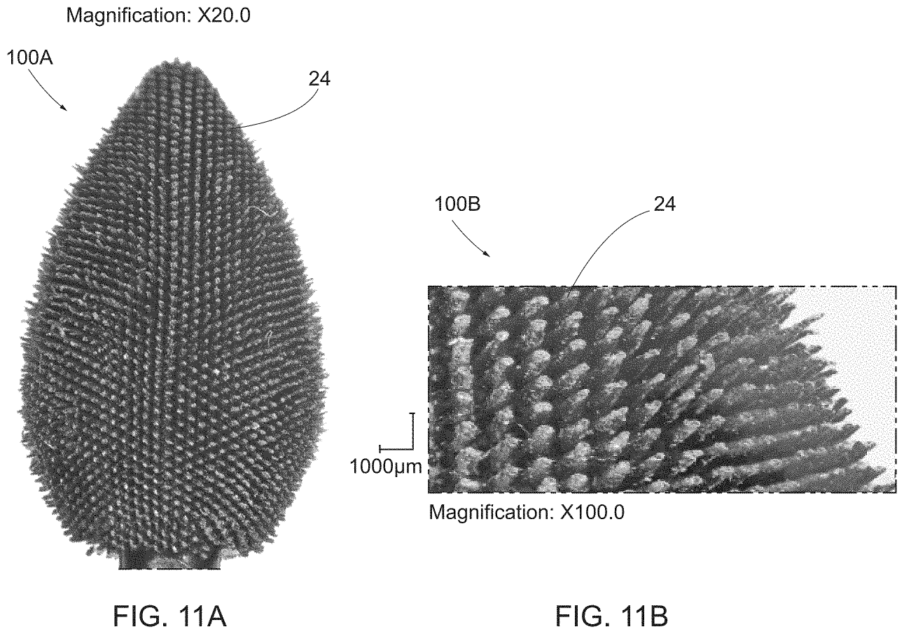

FIGS. 11A and 11B depict cosmetic applicators, according to an embodiment of the present disclosure. Each flock-like extension 24 may be formed from the injection moldable material of the applicator head 4 (FIGS. 1 and 2). These flock-like extensions 24 may be integrally formed with the applicator head 4. In other words, applicator head 4 and the flock-like extensions 24 for a unibody construction without adhesives or other bonding techniques necessary to attach the flock-like extensions 24 to the applicator head 4.

Generally, the injection molding method is performed in a manner similar or identical to known methods. Thus, injection molding method further comprising the steps of: introducing the injection molding material into the mold cavity 52 at a temperature greater than a temperature at which the injection molding material melts, such that the injection molding material is in a completely molten state; and solidifying the injection molding material within the mold 52 cavity such that the mold cavity 52 surface finish is transferred to the applicator 1 as the injection molding material solidifies.

In summary, a method and an apparatus as described herein achieves a flocked effect within an injection mold. The flocked effect is the same or similar to a flocked effect achieved in a secondary process. A mold cavity surface is etched with fine micro-deep textures to allow thermoplastic material to flow into the fine micro-deep textures to mimic flocked fibers upon curing. The cured thermoplastic material from the fine micro-deep textures provides a velvety fibrous texture.

Advantages of the present invention include, but are not necessarily limited to:
no secondary flocking process is necessary to produce the flocked effect;
elimination of compatibility concerns between the thermoplastic material of the applicator and the material of producing the flocked effect;
consistent quality by high replication and repeatability part to part;
wider material selection tailored to achieve desired tactile feeling, product deposition and transfer;
provides precise control over the structural geometry of the flocked effect surface in terms of selective flocking, spacing, diameter to depth ratio, and combination
safer to use without concern of flocked fiber falling off or transfer to product or skin;
no adhesion failure/peeling issues related to conventional secondary flocking; and
wider design opportunities because conventional flocking cannot produce controlled or different geometries, or a combination of geometries of velvety features. Also, patterns can be created on the surface by selectively choosing the areas to flock (such as polka dot, logos, etc.).

While the specific embodiments have been illustrated and described, numerous modifications come to mind without significantly departing from the spirit of the invention, and the scope of protection is only limited by the scope of the accompanying claims.

What is claimed is:

1. A method of producing a cosmetics applicator, comprising the step of:
introducing a thermoplastic material into a mold cavity, the mold cavity comprising a surface which engages the thermoplastic material, the surface comprising a plurality of micro-etched features recessed therein.

2. The method of claim 1, wherein each micro-etched feature has a depth between 0.08 millimeters (mm) and 0.35 mm.

3. The method of claim 1, wherein the surface of the mold cavity comprises one or more smooth areas, the one or more smooth areas comprising at least one of a non-micro etched surface or a micro-etched surface having a depth less than 0.08 mm.

4. The method of claim 3, wherein each of the plurality of micro-etched features is separated by a first smooth area of the one or more smooth areas.

5. The method of claim 4, wherein the depth of a first micro-etched feature is not equal to the depth of a second micro-etched feature.

6. The method of claim 5, wherein a pattern of the plurality of micro-etched features defines a flocking geometry.

7. The method of claim 6, wherein the mold cavity surface has a distal end separated from a proximal end by an intermediate portion, and
wherein the flocking geometry is at least partially defined by a first set of micro-etched features in the intermediate portion having a deeper depth than the respective depths of a second set of micro-etched features in the plurality of micro-etched features and a third set of micro-etched features in the plurality of micro-etched features.

8. The method of claim 7, wherein the distal end of the mold cavity is configured to produce a free end of the applicator, and the proximal end of the mold cavity is configured to produce at least a portion of a handle of the applicator.

9. The method of claim 8, wherein the mold cavity tapers from the intermediate portion to the distal end such that a cross-sectional area of the mold cavity taken transverse to a length of the mold cavity at the distal end is less than a cross-sectional area taken transverse to the length of the mold cavity in the intermediate portion.

10. The method of claim 9, wherein the mold cavity is formed within a mold body, the mold body comprising a first mold body portion in face-to-face relationship with a second mold body portion wherein a first portion of the mold cavity is recessed within the first mold body portion and a second portion of the mold cavity is recessed within the second mold body portion.

11. The method of claim 10, wherein the plurality of micro-etched features is located within one of the first portion of the mold cavity or the second portion of the mold cavity.

12. The method of claim 11, wherein the thermoplastic material has a hardness less than or equal to 60 Shore A.

13. The method of claim 12, wherein the thermoplastic material is an elastomer.

14. The method of claim 13, further comprising the steps of:
introducing the thermoplastic material into the mold cavity at a temperature greater than a temperature at which the thermoplastic material melts, such that the thermoplastic material is in a completely molten state; and
solidifying the thermoplastic material within the mold cavity such that the mold cavity surface finish is transferred to the applicator as the thermoplastic material solidifies.

15. An applicator produced according to the method of claim 14, the applicator comprising:
a head of a thermoplastic material positioned about a longitudinal axis, the head having a distal end forming a free end of the applicator and a proximal end terminating in a handle, the head further comprising an exposed outer surface; and
a plurality of flock-like extensions extending radially outwardly from the exposed outer surface in relation to the longitudinal axis and integrally formed with the head.

16. A cosmetic applicator, comprising:
a head of a thermoplastic material positioned about a longitudinal axis, the head having a distal end forming a free end of the cosmetic applicator and a proximal end terminating in a handle, the head further comprising an exposed outer surface; and
a plurality of flock-like extensions extending radially outwardly from the exposed outer surface in relation to the longitudinal axis, each flock-like extension in the plurality of flock-like extensions is formed from the thermoplastic material and is integrally formed with the head.

17. The cosmetic applicator of claim 16, wherein each flock-like extension in the plurality of flock-like extensions has a length extending at least 0.08 mm from the exposed outer surface of the applicator.

18. The cosmetic applicator of claim 17, wherein the length of each flock-like extension in the plurality of flock-like extends no more than 0.35 mm from the exposed outer surface of the applicator.

19. The cosmetic applicator of claim 18, wherein the plurality of flock-like extensions is arranged in a flocking geometry, and the distal end of the applicator is separated from the proximal end of the applicator by an intermediate portion, and
wherein the flocking geometry is at least partially defined by the length of a first set of the plurality of flock-like extensions extending radially outwardly relative to the longitudinal axis in the intermediate portion being greater than respective lengths of a second set of the plurality of flock-like extensions at the distal end of the applicator and a third set of the plurality of flock-like extensions at the proximal end of the applicator.

20. The cosmetic applicator of claim 16, wherein the exposed outer surface comprises one or more smooth areas, the one or more smooth areas comprising at least one of a non-flocked region defined by an absence of flock-like extensions or a set of flock-like extensions in the plurality flock-like extensions extending radially outwardly relative to the longitudinal axis having lengths less than 0.08 mm.
